(19) United States
(12) Patent Application Publication
(10) Pub. No.: US 2012/0019555 A1
(43) Pub. Date: Jan. 26, 2012

(54) SYSTEM, METHOD, AND COMPUTER SOFTWARE CODE FOR DISPLAYING CONCURRENT AND CONTEXTUAL DISPLAY OF INFORMATION IN SEPARATE DISPLAY CONTAINERS ON A VISUAL SCREEN

(76) Inventor: Hutch K. Hicken, Fern Park, FL (US)

(21) Appl. No.: 13/190,303

(22) Filed: Jul. 25, 2011

Related U.S. Application Data
(60) Provisional application No. 61/367,395, filed on Jul. 24, 2010.

(51) Int. Cl. G09G 5/377

(52) U.S. Cl. 345/629

(57) ABSTRACT

A system for displaying information on a display, the system including a display, a processor that provides information on the display based on commands received by the processor, and at least one computer process operable with the processor. The at least one computer process is configured to display a first set of information in a first display container when commanded, the first set of information possesses at least one link that when activated provides a second set of information in a second display container, the first set of information in the first display container is partially obscured by the second display container, but non-obscured information in the first display container remains accessible while the second display container also remains accessible and visible. A method and computer software computer code for displaying information on a display are also disclosed.

### CROSS-REFERENCE TO RELATED APPLICATIONS

This application claims the benefit of U.S. Provisional Application No. 61/367,395 filed Jul. 24, 2010, and incorporated herein by reference in its entirety.

### BACKGROUND OF THE INVENTION

Embodiments of the present invention relate to displaying overlapping information on a display or in a viewing area, such as, but not limited to, the viewing area provided on a tablet computer and, more particular, to a system, method, and computer software code for displaying user-selected content on a display or screen.

A tablet computer, or simply tablet, is a mobile computer which is integrated into a flat touch screen and primarily operated by touching the screen. It often uses an onscreen virtual keyboard or a digital pen rather than a physical keyboard. Computing devices with data input and output on a flat information display have existed as early as 1888. Throughout the 20th century many devices with these characteristics have been ideated and created whether as blueprints, prototypes or commercial products.

An exemplary example of a tablet computer is an iPad. In April 2010, Apple, Inc. released the iPad, a tablet computer focused on media consumption. The shift in purpose, together with increased usability and overall quality with respect to previous tablets, essentially created a new class of consumer device. More specifically, the iPad is a line of tablet computers designed, developed and marketed primarily as a platform for audio-visual media including books, periodicals, movies, music, games, and web content. Its size and weight falls between those of contemporary cellular smartphones and laptop computers. The iPad runs the same operating system as two other devices offered by Apple, Inc., a portable media player known as an iPod Touch and a cellular Smartphone known as an iPhone. The iPad can run its own applications as well as iPhone applications. Without modification, the iPad will only run programs approved by Apple and distributed via the Apple App Store (with the exception of programs that run inside the iPad's web browser).

Like the iPhone and the iPod Touch, the iPad is controlled by a multi-touch display as well as a virtual onscreen keyboard in lieu of a physical keyboard. The iPad uses a wireless local area network (“Wi-Fi”) connection to access local area networks and the Internet. Currently when new material is displayed on the display, such as an electronic or digital magazine, though pages from the magazine are visible, if there are hyperlinks, such as associated with websites of advertisers, accessing the hyperlinks results in the advertiser's website becoming the primary window, usually covering the original window.

When tablet computers are used to display information which has hyperlinks embedded within the displayed information, selecting the hyperlink will produce a new window covering or overlapping the original screen. Only one screen of information is operable however. More specifically, when the new screen is visible after selecting the hyperlink, the user can scroll through content on the new screen and even select any hyperlinks on the new screen. However, should the user return to the original screen, such as by touching the display where the original screen is not obscured by the new screen, the new screen is positioned behind the original screen and is no longer viewable. To view the new screen again, the user would have to take an action, such as minimizing the original screen, in order to again view the new screen. Having to take such actions limits the functionality of having applications that provide for multiple screen presentations. Because the display on tablet computers is small, allowing two screens to be fully visible on the display results in the screens being too small to read for most users. Thus, users, application developers, and tablet manufacturers would benefit from a technique that would allow parts of multiple screens to be visible at the same time and remain operable (or visible) when a user interacts with the visible parts of any one particular screen.

### BRIEF DESCRIPTION OF THE INVENTION

Embodiments of the present invention relate to a system, method, and computer software code for displaying user-selected content on a display or screen. The system comprises a display, a processor that provides information on the display based on commands received by the processor, and at least one computer process operable with the processor. The at least one computer process is configured to display a first set of information in a first display container when commanded. The first set of information possesses at least one link that when activated provides a second set of information in a second display container. The set of information in the first display container is partially obscured by the second display container, but non-obscured information in the first display container remains accessible while the second display container also remains accessible and visible.

The method comprises displaying a first set of information, when a processor is commanded, in a first display container. The method further comprises providing at least one link within the first set of information that when commanded by the processor accesses a second set of information not currently displayed. The method also comprises opening a second display container displaying the second set of information when the link is activated wherein the second container may partially obscure the first display container. The method also comprises allowing both the first set of information in the first display container that is not obscured by the second display container and the second set of information in the second display container to remain accessible.

The computer software code is stored on a computer readable medium and configured for execution with a processor designated for displaying information on a display. The computer software code comprises a computer software module for displaying a first set of information, when a processor is commanded, in a first display container, when operated with a processor. The computer software code also comprises a computer software module for providing a link within the first set of information that when commanded by the processor accesses a second set of information not currently displayed, when operated with the processor. The computer software code further comprises a computer software module for opening a second display container displaying the second set of information when the link is activated where the second container may partially obscure the first display container, when operated with the processor. The computer software code also comprises a computer software module for allowing both the first set of information in the first display container that is not obscured by the second display container and the second set of information in the second container to remain accessible, when operated with the processor.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not, therefore, to be considered limiting of its scope, the invention will be described and explained with additional specificity and detail through the use of the accompanying drawings in which:

FIG. 1 depicts an exemplary embodiment of a block diagram of a system for displaying information on a display;

FIG. 2 depicts an exemplary content page as may be delivered to a display;

FIG. 3 depicts another exemplary embodiment when a link is activated in the first display container resulting in a second display container;

FIG. 4 depicts an exemplary embodiment of the content page including a second container possessing information from the first content container provided in another format;

FIG. 5 depicts another exemplary embodiment of FIG. 3 wherein the second display container may be positioned a plurality of locations;

FIG. 6 depicts another exemplary embodiment of a content page delivered in a landscape configuration;

FIG. 7 depicts an exemplary embodiment when the second display container is used with the content page; and

FIG. 8 depicts a flowchart of a method for displaying information on the display.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts. As disclosed below, multiple versions of a same element may be disclosed. Likewise, with respect to other elements, a singular version is disclosed. Neither multiple versions disclosed nor a singular version disclosed shall be considered limiting. Specifically, although multiple versions are disclosed, a singular version may be utilized. Likewise, where a singular version is disclosed, multiple versions may be utilized.

Though exemplary embodiments of the present invention are described with respect to tablet computers, the invention is also applicable with other computer screens or displays, especially other touch screen displays. However, exemplary embodiments of the invention are also application with displays that are not touch screen activated, such as those that require an electronic cursor to activate content displayed on the display.

Exemplary embodiments of the invention solve problems in the art by providing a method, system, and computer implemented method, such as a computer software code or computer readable media operable with a processor, for displaying information on a display. Persons skilled in the art will recognize that an apparatus, such as a data processing system, including a CPU, memory, I/O, program storage, a connecting bus, and other appropriate components, could be programmed or otherwise designed to facilitate the practice of the method of the invention. Such a system would include appropriate program means for executing the method of the invention.

Also, an article of manufacture, such as a pre-recorded disk, computer readable media, or other similar computer program product, for use with a data processing system, could include a storage medium and program means recorded thereon for directing the data processing system to facilitate the practice of the method of the invention. Such apparatus and articles of manufacture also fall within the spirit and scope of the invention.

Broadly speaking, a technical effect is to allow both a first set of information in a first display container that is not obscured by a second container and a second set of information in the second container to remain accessible to a user. To facilitate an understanding of the exemplary embodiments of the invention, it is described hereinafter with reference to specific implementations thereof. Exemplary embodiments of the invention may be described in the general context of computer-executable instructions, such as program modules, being executed by any device such as, but not limited to, a computer, designed to accept data, perform prescribed mathematical and/or logical operations usually at high speed, where results of such operations may or may not be displayed. Generally, program modules include routines, programs, objects, components, data structures, etc., that perform particular tasks or implement particular abstract data types. For example, the software programs that underlie exemplary embodiments of the invention can be coded in different programming languages, for use with different devices, or platforms. In the description that follows, examples of the invention may be described in the context of a web portal that employs a web browser. It will be appreciated, however, that the principles that underlie exemplary embodiments of the invention can be implemented with other types of computer software technologies as well.

Moreover, those skilled in the art will appreciate that exemplary embodiments of the invention may be practiced with other computer system configurations, including multiprocessor systems, microprocessor-based or programmable consumer electronics, minicomputers, mainframe computers, and the like.

Referring now to the drawings, embodiments of the present invention will be described. Exemplary embodiments of the invention can be implemented in numerous ways, including as a system (including a computer processing system), a method (including a computerized method), an apparatus, a computer readable medium, a computer program product, a graphical user interface, including a web portal, or a data structure tangibly fixed in a computer readable memory. Several embodiments of the invention are discussed below. Reference will be made below in detail to exemplary embodiments of the invention, examples of which are illustrated in the accompanying drawings.

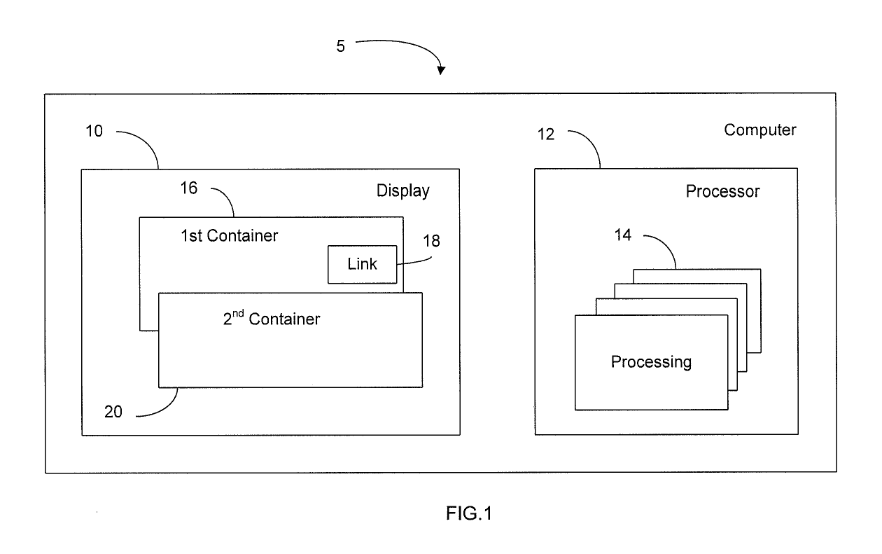

FIG. 1 depicts an exemplary embodiment of a system for displaying user-selected content on a display or screen. As illustrated, a display 10 is provided, such as, but not limited to, a display that is provided with a tablet computer 5. A processor 12 is connected to the display 10 so that when commanded, the processor provides information that is viewable on the display. The term “information” is not meant to be limiting. Information may be text based, visual images, and/or any other forms of information that may be displayed on a computer screen. A plurality of computer processes 14 is provided that is operable with the processor.

Though a plurality of computer processes is stated, the processes could be a single computer process with or without multiple functionalities. Thus, the term “plurality of computer processes” is not meant to be limiting as this term is meant to also cover what may be defined as a single process required to allow a computer application to operate. The single process still would have mini or micro processes that must be executed in order for the single process to perform a given task. For example, at a minimum, a plurality of computer processes display a first set of information in a first display container when commanded, as disclosed herein, is meant to cover whether a single process (if so configured) or several processes that together provide the functionality disclosed.

The plurality of computer processes, or at least one computer process, 14 is provided to display a first set of information in a first display container 16. The first set of information may contain a link 18, such as, but not limited to, a hyperlink, that when activated provides a second display container 20 that provides for additional information.

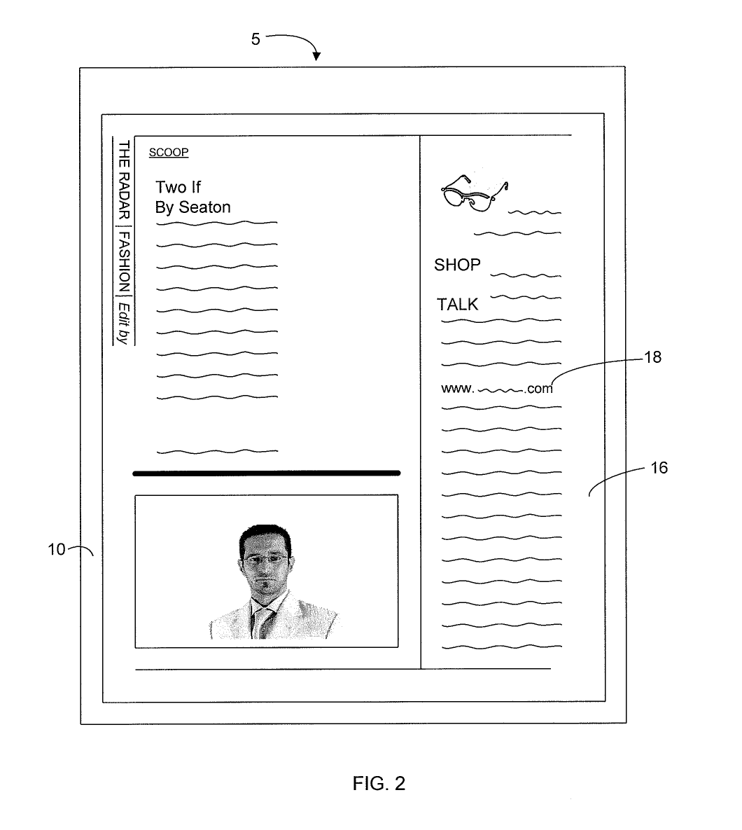

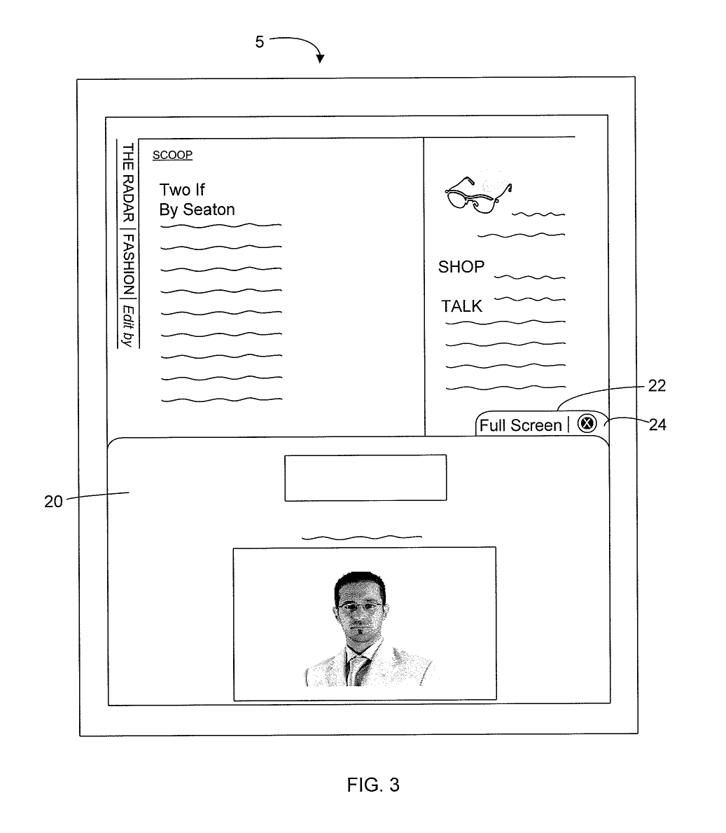

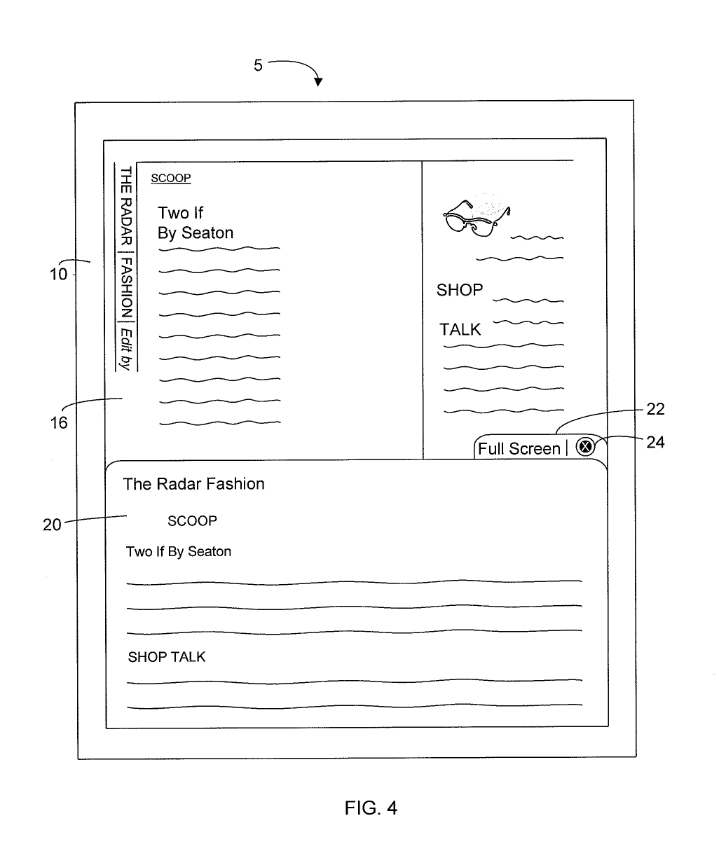

For example, FIG. 2 depicts an example of the first set of information that may be provided. The first set of information is displayed in the first display 16 container. In FIG. 2, the first set of information is a page from a magazine that is provided electronically, such magazines may be referred to as an electronic magazine or digital magazine, to a user via the tablet computer 5. In this embodiment, the magazine page is displayed in a portrait view. The links 18, such as, but not limited to, a hyperlink, are associated with the information contained on this magazine's page. For example, the hyperlink may direct a user to an advertiser's website, or additional information about a product being advertised, such as illustrated in FIG. 3, where a second display container 20 is opened when the link is activated. In another example, the link may be configured to allow content of specific information, such as a specific article, to be provided in the second display container 20, such as, but not limited to, displaying the article in larger font, as is illustrated in FIG. 4. As is currently provided with tablet computers 5, accessing the links 18 may be done by tapping, or touching the display where the link is located. Touching the display may be considered as a functional feature that is a part of the display. For some links, the complete screen may activate the link 18 by touching anywhere on the display, or screen, 10.

Even though the set of information in the first display container 16 is partially obscured by the second display container 20, the non-obscured information in the first display container 16 remains accessible to the user while the second display container 20 also remains accessible and visible. Thus, the user is able to continue scrolling through the information in the first display container 16, and accessing other links, or even transitioning to another page of information (, such as, but not limited to, another page in the digital magazine), while the second display container 20 continues to obscure part of the first display container 16. However, the user is unable to access the information in the first display container 16 when it is obscured by the second display container 20. This obscured information will only be accessible when the second display container 20 is no longer obscuring the information.

With respect to turning to another page in the electronic magazine, doing so may either leave the second display container 20 visible, automatically close the second display container 20, or providing new content in the second display container 20 similar to the container that was being viewed when on the prior page. For example, if the second display container 20 is used to display an article, possibly in a larger font, an article on the new page may be automatically displayed in the second display container 20, or the second display container will be populated, when the new page is selected. Those skilled in the art will readily recognize that many options exist as to what to display or not to display in an activated second display container 20 when the new page is selected, but using an exemplary embodiment of the disclosed invention to provide such information with the functionality discussed herein is clearly novel and not obvious.

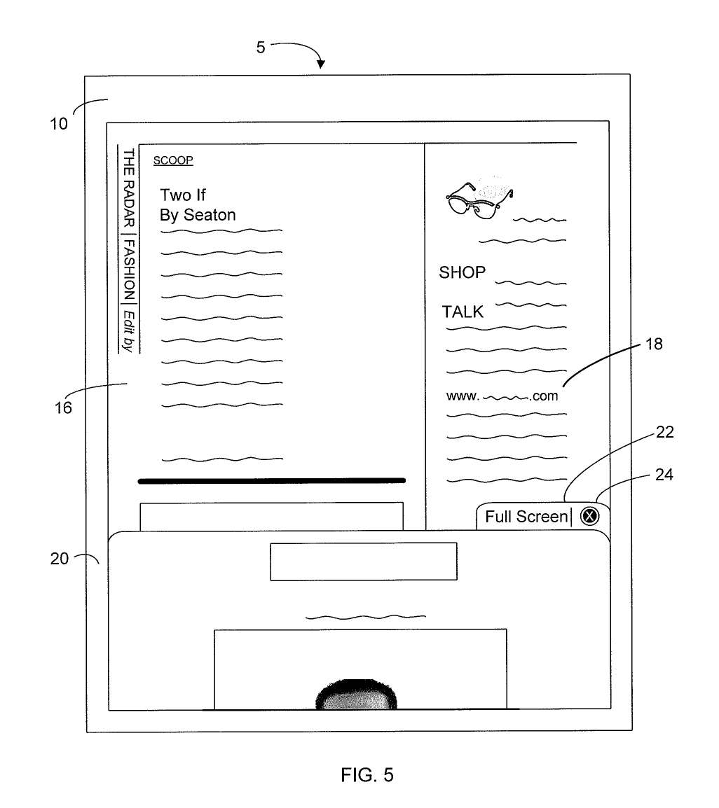

The second display container 20 does not have to be static, or locked to a certain position on the display 10. As illustrated, when comparing FIG. 3 to FIG. 5, the second display container 20 may be positioned where all information in the second display container 20 is not visible, thus allowing for more information in the first display container 16, once obscured by the second display container 20, to become visible. If desired, the second display container 20 may completely cover the entire first display container 16, but activating a “full screen” link 22, or sizing link. As further illustrated, a closing link 24 may be provided on the second display container 20 to close it at the user's discretion. Additionally, when a new link, or second link, is selected when the second display container 20 is already visible, the new information associated with the new link will load in the second container, thus replacing the information previously provided.

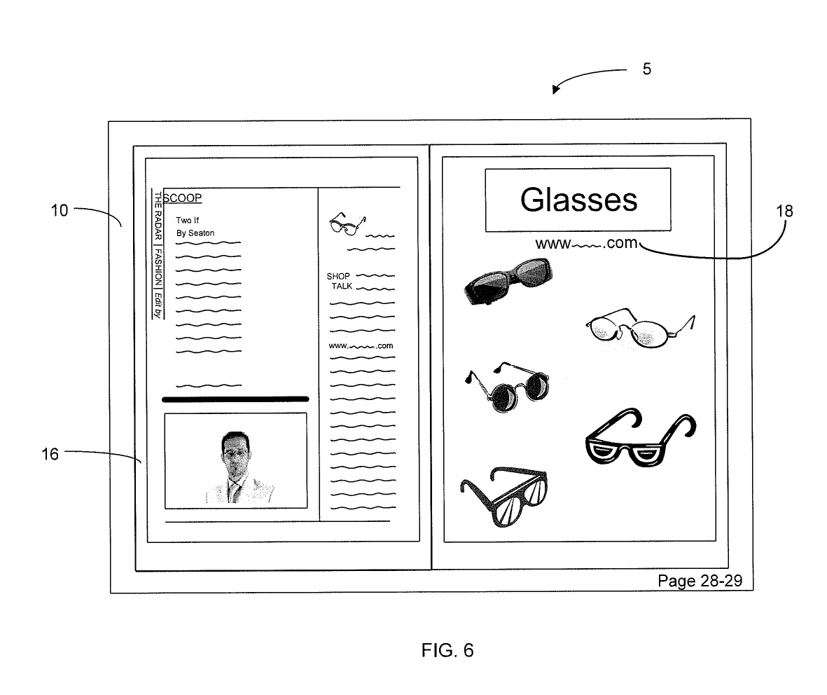

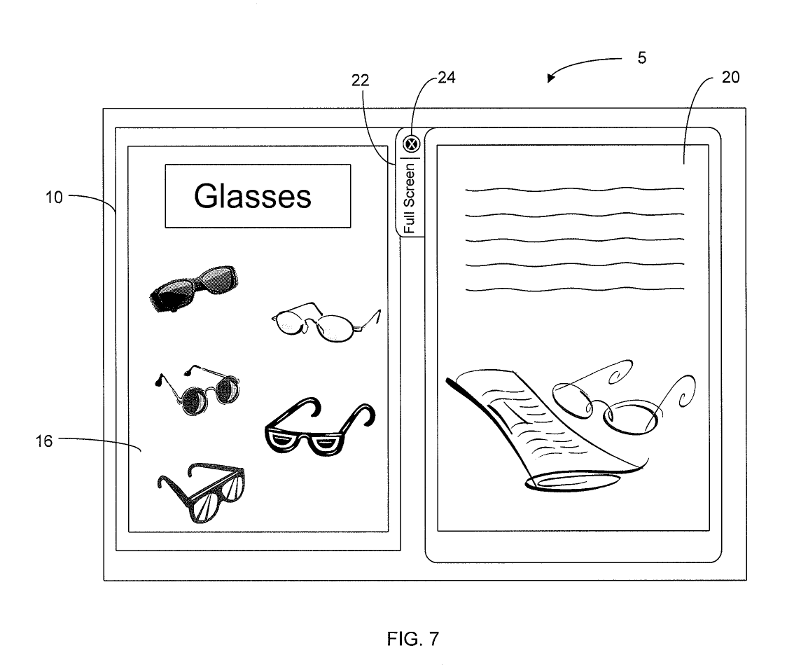

In another exemplary embodiment, as illustrated in FIG. 6, when a landscape view of the information is preferred, two adjacent pages of the electronic magazine may be viewed at the same time in the first display container 16. As illustrated in FIG. 7, selecting a link results in the second display container 20 being displayed. In an exemplary embodiment, and as illustrated in FIG. 7, when the link 18 selected on the second page displayed in landscape mode of the first display container 16, the second page is transitioned to the location of the first page and the second display container 20 obscures the page that immediately follows the page with the selected link 18. Also, the first set of information is displayed in a portrait configuration and/or a landscape configuration, the second set of information in the second display container is displayed in an equivalent configuration.

To allow for the two display containers 16, 20 to operate, as explained herein, where both may be accessible by the user without having the current one being accessible automatically covering the second display container, the software code for each container may be configured to allow for each container to be launched when the link, or another triggering event, such as, but not limited to, when the first container is opened when an application is selected, occurs. The programming language used for the code may be one associated with the type of operating system used on a particular computer, tablet computer, and/or tablet computer system.

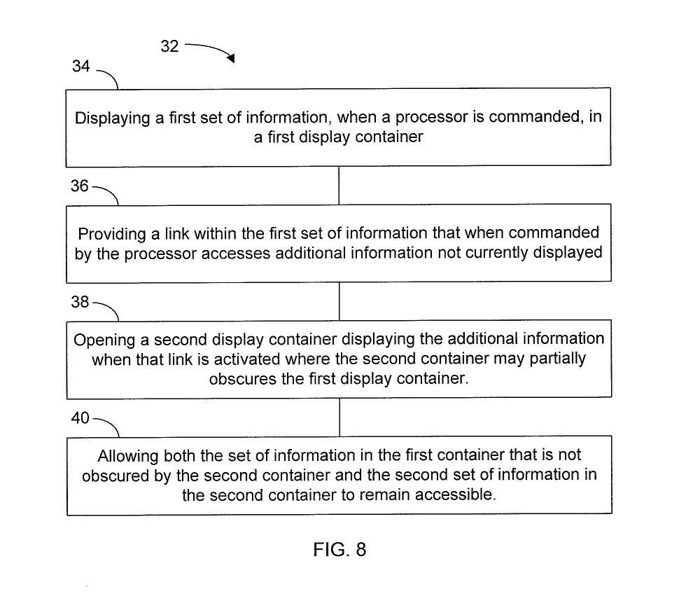

FIG. 8 discloses an exemplary embodiment of a flow chart illustrating a method for displaying information on a display. As illustrated, the method 32 in the flowchart discloses a first set of information, when a processor is commanded, is displayed in a first display container, at 34. A link within the first set of information is provided that when commanded by the processor accesses additional information not currently displayed, at 36. A second display container is opened displaying the additional information when the link is activated where the second container may partially obscure the first display container, at 38. Both the first set of information in the first container that is not obscured by the second container and the second set of information in the second container are allowed to remain accessible, at 40.

The exemplary methods shown in flowchart 30 may be performed with a computer software code having computer software modules where the computer software code is stored on a computer media and is executed with a processor 12. Thus, each element in the flowchart illustrating the method 30 may be performed by a computer software module specific to perform the element. For example, displaying a first set of information, when a processor is commanded, in a first display container, at 34, may be performed by a computer software module displaying a first set of information, when a processor is commanded, in a first display container, when operated with the processor. Likewise, providing a link within the first set of information that when commanded by the processor accesses additional information not currently displayed, at 36, may be performed by a computer software module for providing a link within the first set of information that when commanded by the processor accesses additional information not currently displayed when operated with the processor. Opening a second display container displaying the additional information when the link is activated where the second container may partially obscure the first display container, at 38, may be performed by a computer software module for opening a second display container displaying the additional information when the link is activated where the second container may partially obscure the first display container, when operated with the processor. Furthermore, allowing both the first set of information in the first display container that is not obscured by the second display container and the second set of information in the second container to remain accessible, at 40, may be performed by a computer software module for allowing both the first set of information in the first display container that is not obscured by the second display container and the second set of information in the second container to remain accessible, when operated with the processor.

While the invention has been described with reference to various exemplary embodiments, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated, any use of the terms first, second, etc., does not denote any order or importance, but rather the terms first, second, etc., are used to distinguish one element from another.

What is claimed is:

1. A system for displaying information on a display, the system comprising:
a display;
a processor that provides information on the display based on commands received by the processor; and
at least one computer process operable with the processor;
wherein the at least one computer process is configured to display a first set of information in a first display container when commanded, the first set of information possesses at least one link that when activated provides a second set of information in a second display container, the set of information in the first display container is partially obscured by the second display container, but non-obscured information in the first display container remains accessible while the second display container also remains accessible and visible.

2. The system according to claim 1, wherein the display is part of a tablet computer system.

3. The system according to claim 1, wherein the at least one link is a hyperlink that is located within information on the display and/or is a functional feature that is a part of the display.

4. The system according to claim 3, wherein the functional feature that is a part of the display comprises a display that is a touch activated display.

5. The system according to claim 1, wherein the at least one computer process further is configured to allow the second display container to be moved about the display to allow for obscured information to be non-obscured.

6. The system according to claim 5, wherein the second display container may be moved where a part of the second display container is not visible on the display.

7. The system according to claim 1, further comprising a sizing link associated with the second display container configured to activate sizing of second display container.

8. The system according to claim 1, further comprising a closing link associated with the second display container configured to close the second display container.

9. A method for displaying information on a display, the method comprising:
displaying a first set of information, when a processor is commanded, in a first display container;
providing at least one link within the first set of information that when commanded by the processor accesses a second set of information not currently displayed;
opening a second display container displaying the second set of information when the link is activated wherein the second container may partially obscure the first display container; and
allowing both the first set of information in the first display container that is not obscured by the second display container and the second set of information in the second display container to remain accessible.

10. The method according claim 9, further comprising repopulating the second display container with a different second set of information associated with a second link when the second link is activated.

11. The method according to claim 9, further comprising displaying the first set of information in a portrait and/or landscape configuration and displaying the second set of information in the second display container in an equivalent configuration.

12. The method according to claim 9, further comprising expanding the second display container to completely cover the first display container.

13. The method according to claim 9, further comprising that when the information in the first display container is changed, populating the second display container with a new second set of information in the second display container of a similar type of the second set of information that was previously displayed in the second display container prior to the information in the first display container being changed.

14. The method according to claim 9, wherein the opening a second display container displaying the second set of information comprises the second set of information being a larger font of the first set of information.

15. A computer software code stored on a computer readable medium and configured for execution with a processor designated for displaying information on a display, the computer software code comprising:
a computer software module for displaying a first set of information, when a processor is commanded, in a first display container, when operated with a processor;
a computer software module for providing a link within the first set of information that when commanded by the processor accesses a second set of information not currently displayed, when operated with the processor;
a computer software module for opening a second display container displaying the second set of information when the link is activated where the second container may partially obscure the first display container, when operated with the processor; and
a computer software module for allowing both the first set of information in the first display container that is not obscured by the second display container and the second set of information in the second container to remain accessible, when operated with the processor.

16. The computer software code according claim 15, further comprising a computer software module for repopulating the second display container with a different second set of information associated with a second link when the second link is activated, when operated with the processor.

17. The computer software code according to claim 15, further comprising a computer software module for displaying the first set of information in a portrait and/or landscape configuration and displaying the second set of information in the second display container in an equivalent configuration, when operated with the processor.

18. The computer software code according to claim 15, further comprising a computer software module for expanding the second display container to completely cover the first display container, when operated with the processor.

19. The computer software code according to claim 15, further comprising that when the information in the first display container is changed, a computer software module for populating the second display container with a new second set of information in the second display container of a similar type of the second set of information that was previously displayed in the second display container prior to the information in the first display container being changed, when operated with the processor.
